(19) United States
(12) Patent Application Publication
(10) Pub. No.: US 2008/0052327 A1
(43) Pub. Date: Feb. 28, 2008

(54) Secondary Backup Replication Technique for Clusters

(75) Inventor: Patrick A. Buah, Poughkeepsie, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/467,645

(22) Filed: Aug. 28, 2006

(51) Int. Cl. G06F 17/30

(52) U.S. Cl. 707/204

(57) ABSTRACT

A method, system and program product for backing up a replica in a cluster system having at least one client, at least one node, a primary replica, a secondary replica, and a secondary-backup (S-backup) replica each replicating a process running on the cluster system. A hierarchy is assigned to each of the primary, secondary and S-backup replicas. The failure of one of the replicas is detected and the failing replica is replaced with one of lower hierarchy. The replica having the lowest affected hierarchy is regenerated to reestablish the primary replica, secondary replica, and S-backup replica.

### FIELD OF THE INVENTION

This invention relates to replication of a component of a clustered computer system, and more particularly to a backup replication for backing up the secondary replica of a component of a clustered computer system.

### BACKGROUND OF THE INVENTION

A major inherent problem in clustered systems is their potential vulnerability to failures. When a single node in the cluster crashes, availability of the whole system may be compromised. Redundancy to increase the reliability of the system is normally introduced into the system by the replication of components. Replicating a service or process in a distributed system requires that each replica of the service keeps a consistent state. This consistency is ensured by a specific replication protocol. There are different ways to organize process replicas and one generally distinguishes between active, passive and semi-active replication.

In the active replication technique, also called the state-machine approach, every replica handles requests received from a client and sends a reply. The replicas behave independently and the technique consists in ensuring that all replicas receive the requests in the same order. This technique has low response time in the case of a crash. However, because all replicas handle all requests in parallel, a significant run-time overhead is incurred, thus making it an unrealistic choice for high-availability solutions for commercial applications.

with the passive replication technique, also called Primary-Backup, one of the replicas, called the primary, receives requests from the clients and returns responses. The backups interact with the primary only, and receive state update messages from the primary. If the primary fails, one of the backups takes over. Unlike active replication, it requires less processing power than active replication and makes no assumption on the determinism of processing a request. However, there is significantly increased response time in the case of failure that makes it unsuitable in the context of time-critical applications.

The semi-active replication technique circumvents the problem of non-determinism with active replication, in the context of time-critical applications. The technique is based on active replication and extended with the notion of leader and followers. While the actual processing of a request is performed by all replicas, it is the responsibility of the leader to perform the non-deterministic parts of the processing and inform the followers. This technique is close to active replication, with the difference that non-deterministic processing is possible. However, significant recovery time overhead is incurred in the case of a failure of the primary replica.

U.S. Pat. No. 6,189,017 B1 issued Feb. 13, 2001 to Ronstrom et al. for METHOD TO BE USED WITH A DISTRIBUTED DATA BASE, AND A SYSTEM ADAPTED TO WORK ACCORDING TO THE METHOD discloses a method for ensuring the reliability of a system distributed data base having several computers forming nodes. A part of the data base includes a primary replica and a secondary replica. The secondary replica is used to re-create the primary replica should the first node crash.

U.S. Pat. No. 6,802,024 B2 issued Oct. 5, 2004 to Unice for DETERMINISTIC PREEMPTION POINTS IN OPERATING SYSTEM EXECUTION discloses methods and apparatus to provide fault-tolerant solutions utilizing single or multiple processors having support for cycle counter functionality. The apparatus includes a primary system and a secondary system. An output facility provides system output only form the secondary system if only a first interrupt has occurred and the first interrupt was caused by the secondary system.

U.S. Patent Application Publication No. 2003/0159083 A1 published Aug. 21, 1003 by Fukuhara et al. for SYSTEM, METHOD AND APPARATUS FOR DATA PROCESSING AND STORAGE TO PROVIDE CONTINUOUS OPERATIONS INDEPENDENT OF DEVICE FAILURE OR DISASTER discloses a system, method, and apparatus for providing continuous operations of a user application at a user computing device having at least two application servers. If one of the application servers fails or becomes unavailable, the user requests can be continuously processed be at least the other application server without any delays.

U.S. Patent Application Publication No. 2005/0210082 A1 published Sep. 22, 2005 by Shutt et al for SYSTEMS AND METHODS FOR THE REPARTITIONING OF DATA discloses extending a federation of servers and balancing the data load of the federation servers by moving a first backup data structure on a second server to a new server, creating a second data structure on the new server, and creating a second backup data structure for the second data on the second server.

U.S. Patent Application Publication No. 2005.0268145 A1 published Dec. 1, 2005 by Hufferd et al. for METHODS, APPARATUS AND COMPUTER PROGRAMS FOR RECOVERY FROM FAILURES IN A COMPUTING ENVIRONMENT discloses methods, apparatus and computer programs for recovery from failures affecting a server in a data processing environment in which a set of servers control a client's access to a set of resource instances. Following a failure, the client connects to a previously identified secondary server to access the same resource instance.

Kim, Highly Available Systems for Database Applications, Computing Surveys, Vol. 16, No. 1 (March 1984) provides a survey and analysis of the architectures and availability techniques used in database application systems designed with availability as a primary objective.

Gummadi et al., An Efficient Primary-Segmented backup scheme for Dependable Real-Time Communication in Multihop Networks, IEEE/ACM Transactions of Networking, Vol. 11, No 1 (February, 2003) discloses a segmented backup scheme.

### SUMMARY OF THE INVENTION

A primary object of the present invention is a replication scheme, called “Secondary-Backup Replication,” that makes no assumption on the determinism of processing requests while at the same time reducing both the run-time and recovery time overhead, therefore making it suitable for high-availability and fault-tolerance management of mission-critical and time-critical applications. Existing high-availability cluster solutions such as HACMP available from International Business Machines Corp. of Armonk, N.Y. and Veritas Cluster Server available from Symantic Corp. of Cupertino, Calif. can benefit from such a scheme to support time-critical environments such as telecommunication environments.

Another object of the present invention is a new replication technique for clustered computer systems referred to as “Secondary—Backup” replication. In this technique, a process or a computer node in a cluster is replicated into a group of three replicas or clones. The three process replicas participate in the secondary-backup protocol with the roles of the classical “primary” and “secondary” in addition to a new role introduced by this technique, referred to as the “secondary-backup” or “s-backup”. The s-backup is one of the process or system replicas in the process group that acts as a warm backup to the secondary replica. The primary and secondary replicas participate in a semi-active replication protocol, while a passive-like replication relationship exists between the secondary and the s-backup.

Another object of the present invention is the introduction of a third replica and a low-overhead protocol between the secondary replica and the third replica. Also, there is always only one “follower” involved in the semi-active replication scheme adopted here.

The semi-active replication arrangement, adopted here between the primary and secondary replicas ensures low run-time overhead and instantaneous failover capability while the secondary-backup relationship enables fast recovery or failback in a clustered system. For clusters with processes or systems replicated this way, continuous availability can be guaranteed while response and recovery time in the case of failure is significantly reduced, making it an improved environment for mission-critical and time-critical applications.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a clustered computer system of the present invention,

FIG. 2 illustrates a node, client and communications channel of the clustered computer system of the FIG. 1 wherein the system has a primary replica, a secondary replica, and an S-backup replica,

FIG. 3 is a flowchart of a process wherein the failure of the primary replica of FIG. 2 is detected,

FIG. 4 is a flowchart of a process wherein the failure of the current secondary replica of FIG. 2 is detected, and

FIG. 5 is a flowchart of a process wherein the failure of the S-backup replica of FIG. 2 is detected.

The detailed description explains the preferred embodiments of the invention, together with advantages and features, by way of example with reference to the drawings.

### DETAILED DESCRIPTION OF THE INVENTION

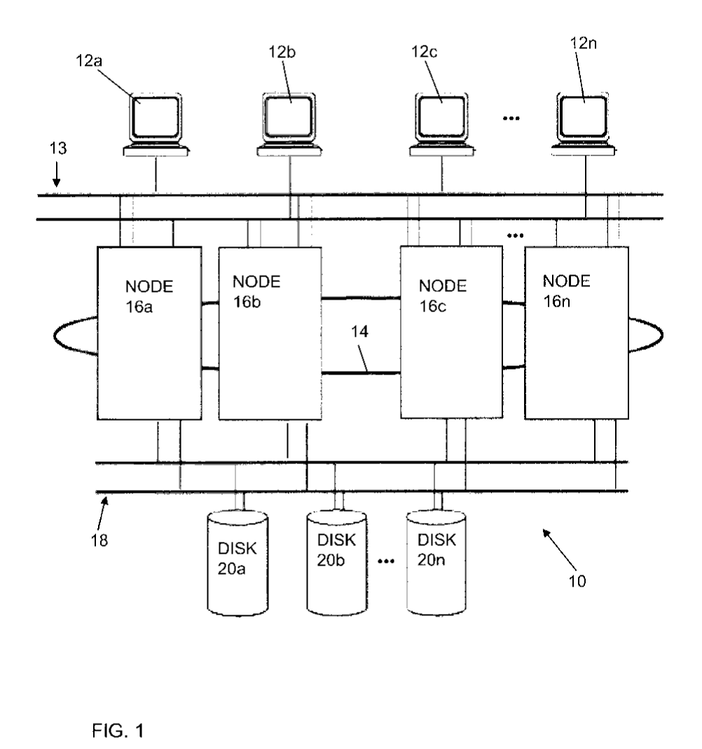

FIG. 1 illustrates one example of a clustered computer system 10 having one or more clients 12a-12n, a communications system 13 and 14, nodes 16a-16n, disk busses 18, and one or more shared disks 20a-20n. It will be understood that the system 10 is an example only, and that other clusters usable with the present invention may look very different depending on the number of processors, the choice of network and the disk technologies used, and so on. It will be understood that a client 12 is a processor that can access the nodes 16 over a local area network such as a public LAN as illustrated at 13 or a private LAN illustrated at 14. Clients 12 each run a “front end” or client application that queries the server application running on a cluster node 16. It will also be understood that in the system of FIG. 1, each node 16 has access to one or more shared external disk devices 20. Each disk device 20 may be physically connected to multiple nodes. The shared disk 20 stores mission-critical data typically configured for data redundancy. The nodes 16 form the core of the cluster system 10. A node 16 is a processor that runs the high-availability and fault-tolerance management software and application software.

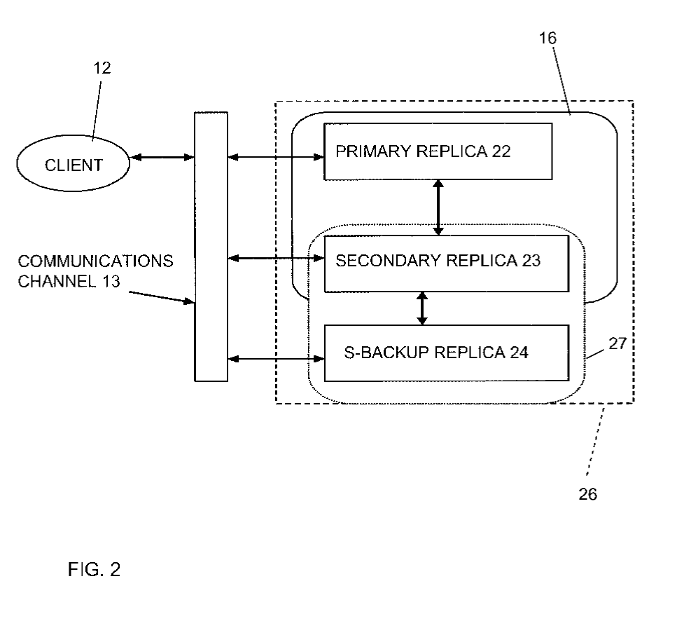

A new replication management technique, Secondary Backup Replication, is disclosed for managing a group of process replicas in high-availability distributed systems. In the Secondary Backup process, one replica acts as a backup for the secondary replica instead of the primary replica as is the case for the usual Primary Backup approach, where the secondary replica backs up the primary replica. FIG. 2 illustrates an integrated replication scheme which consists of three replicas with the designated roles of primary replica 22, secondary replica 23, and S-backup replica 24, participating in a coordinated replication protocol. Both the primary replica 22 and secondary replica 23 process requests, but the primary replica 22 alone or the secondary replica 23 alone sends back replies to the client 12. Cluster software 26 or any other exploiter of the scheme can set, apriori, whether the primary replica 22 or the secondary replica 23 sends responses back to clients. This can also be set dynamically to balance the load between the primary replica 22 and the secondary replica 23. It will be understood that the secondary replica 23 and the S-backup replica 24 may be kept at the same node 16 as the primary replica 22, or elsewhere in the system 10 as desired, as shown at 27. Periodically, the secondary replica 23 synchronizes its state with its backup replica S-Backup replica 24. Optionally, the S-backup replica 24 can be set to poll for state changes on the secondary replica 23.

FIG. 2 illustrates a clustered secondary-backup replication arrangement consisting of a client 12 and three replicas 22, 23, and 14. Each replica can be thought of as a single process or a container running on a single computer system or LPAR image. A replica can also represent a single operating system image, such as AIX or Linux. All three replicas 22, 23, and 24 can also be seen as three separate processes running on a single computer system. Both the primary replica 22 and secondary replica 23 process all client requests, but only the primary replica 22 is responsible for processing all non-deterministic operations. The secondary replica 23 is then forced to make the same decisions made by the primary replica 22. The secondary replica 23 periodically updates the state of the S-backup replica 24, which consists of checkpointing its state changes to the S-backup replica 24, thus minimizing the impact of the s-backup replica 24 on the run-time overhead of the cluster.

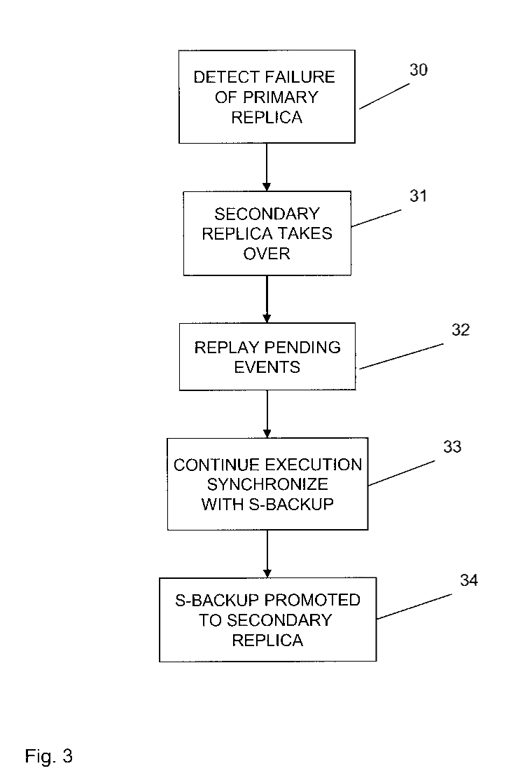

Normally, a failure of a replica in a group changes the group's composition provoking a view change. In the system of FIG. 2, failure or loss of a replica in the system is handled differently depending on the role the failed replica had assumed. Because the S-backup replica 24 does not participate in any interaction beyond the group, its failure is completely transparent with this replica organization. FIG. 3 is a flowchart of a process wherein the failure of the primary replica 22 is detected. At 30, the failure of the primary replica is detected. At 31 upon the detection of a failure of the primary replica 22, the secondary replica 23 instantaneously takes over and continues with the computation, taking on the role of the primary replica 22. At 32, the first thing the secondary replica 23 does is to replay any pending events it had already received from the failed primary replica 22 to bring itself up to date with the last known state of the primary replica 22. At 33, the secondary replica 23 continues execution and synchronizes itself with the S-Backup replica 24, after processing all pending events. At 34/the S-Backup replica 24 is then promoted to the new secondary role as the secondary replica 24.

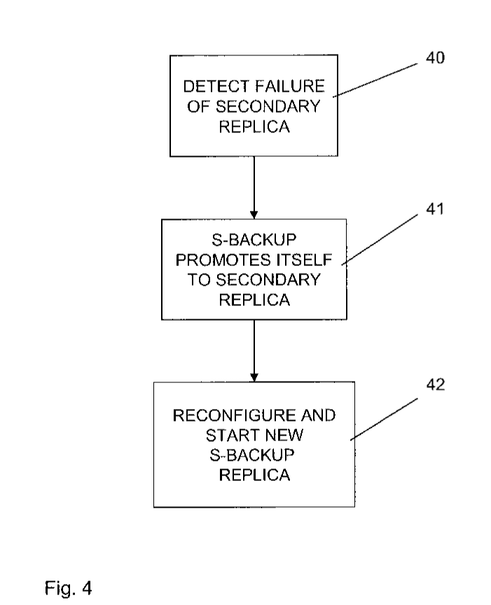

FIG. 4 is a flowchart of a process wherein the failure of the current secondary replica 23 is detected. If the current secondary replica 23 fails, the failure is detected at 40. At 41, the S-backup replica 24 promotes itself to take the secondary role. In the presence of extra resources, at 42 the secondary replica 22 initiates a reconfiguration of the group by starting a new replica which will take on the role of an S-backup replica 24, to restore the original replication degree.

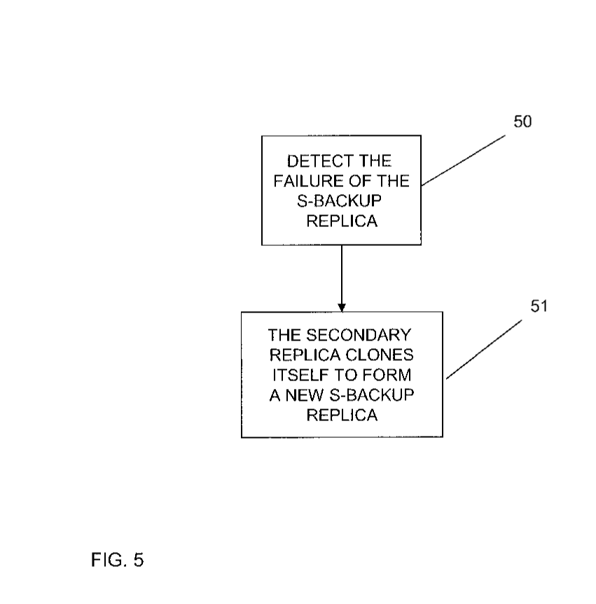

FIG. 5 is a flowchart of a process wherein the failure of the S-backup replica 24 is detected. A failure of the S-backup replica 24 does not affect the state of the cluster since it is not involved in the processing of requests and responses. At 50, the failure of the S-backup replica 24 is detected. At 51, the secondary replica 22 clones itself to create a new S-backup 24 if possible.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

while the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for backing up a replica in a cluster system having at least one client, at least one node, a primary replica, a secondary replica, and a secondary-backup (S-backup) replica each replicating a process running on said cluster system, the method comprising:
assigning a hierarchy to each of said primary, secondary and S-backup replicas;
detecting the failure of one of said replicas;
replacing the failing replica with one of lower hierarchy; and
regenerating the replica having the lowest affected hierarchy thereby reestablishing the primary replica, secondary replica, and S-backup replica.

2. The method of claim 1 wherein the failed replica is the primary replica, and said method further comprises:
taking over the running of said process with said secondary replica;
replaying pending events with said secondary replica such that said secondary replica becomes the new primary replica;
synchronizing said secondary replica with said S-backup replica; and
promoting said S-backup replica as the new secondary replica.

3. The method of claim 1 wherein said failed replica is the secondary replica, and said method further comprises:
promoting the S-backup replica as the new secondary replica; and
reconfiguring and starting a new S-backup replica.

4. The method of claim 1 wherein said failed replica is the S-backup replica, and said method further comprises:
cloning said secondary replica with a copy of itself to form a new S-backup replica.

5. The method of claim 1 wherein the process being replicated by said replicas is a single operating system image such as an AIX or Linux operating system.

6. A cluster system comprising:
at least one client;
at least one node connected to said client:
a primary replica running a process receiving requests from said client and sending responses hack to said client;
a secondary replica receiving requests from said client and duplicating said primary replica; and
a secondary-backup (S-backup) replica synchronized with said secondary replica;
each of said primary, secondary and S-backup replicas being assigned a hierarchy;
a detecting function detecting the failure of one of said replicas;
a replacing function replacing the failing replica with one of lower hierarchy; and
a regenerating function regenerating the replica having the lowest affected hierarchy thereby reestablishing the primary replica, secondary replica, and S-backup replica.

7. The system of claim 6 wherein the failed replica is the primary replica, and wherein
said replacing function takes over the running of said process with said secondary replica and replays pending events with said secondary replica such that said secondary replica becomes the new primary replica, and
said regeneration function synchronizes said secondary replica with said S-backup replica and promotes said S-backup replica as the new secondary replica.

8. The system of claim 6 wherein said failed replica is the secondary replica, and wherein
said replacing function promotes the S-backup replica as the new secondary replica, and
said regenerating function reconfigures and starts a new S-backup replica.

9. The system of claim 6 wherein said failed replica is the S-backup replica, and wherein
said replacing function clones said secondary replica with a copy of itself, and
said regenerating function makes said cloned copy a new S-backup replica.

10. The system of claim 6 wherein the process being replicated by said replicas is a single operating system image such as an AIX or Linux operating system.

11. A program product usable for backing up a replica in a cluster system having at least one client, at least one node, a primary replica, a secondary replica, and a secondary-backup (S-backup) replica each replicating a process running on said cluster system, said program product comprising:
a computer readable medium having recorded thereon computer readable program code performing the method comprising:
assigning a hierarchy to each of said primary, secondary and S-backup replicas;
detecting the failure of one of said replicas;
replacing the failing replica with one of lower hierarchy; and
regenerating the replica having the lowest affected hierarchy thereby reestablishing the primary replica, secondary replica, and S-backup replica.

12. The program product of claim 11 wherein the failed replica is the primary replica, and said method further comprises:
taking over the running of said process with said secondary replica;
replaying pending events with said secondary replica such that said secondary replica becomes the new primary replica;
synchronizing said secondary replica with said S-backup replica; and
promoting said S-backup replica as the new secondary replica.

13. The program product of claim 11 wherein said failed replica is the secondary replica, and said method further comprises:
promoting the S-backup replica as the new secondary replica; and
reconfiguring and starting a new S-backup replica.

14. The program product of claim 11 wherein said failed replica is the S-backup replica, and said method further comprises:
cloning said secondary replica with a copy of itself to form a new S-backup replica.

15. The program product of claim 11 wherein the process being replicated by said replicas is a single operating system image such as an AIX or Linux operating system.
